(19) United States
(12) Patent Application Publication
(10) Pub. No.: US 2024/0272048 A1
(43) Pub. Date: Aug. 15, 2024

(54) CASSETTE FOR HOLDING AND ORIENTING TISSUE SAMPLE

(71) Applicant: LEICA BIOSYSTEMS NUSSLOCH GMBH, Nussloch (DE)

(72) Inventors: Changhong WU, Shanghai (CN); Zhongqiu LI, Shanghai (CN); Jue CHEN, Shanghai (CN)

(21) Appl. No.: 18/570,125

(22) PCT Filed: Jun. 18, 2021
(86) PCT No.: PCT/CN2021/100898

§ 371 Date: Dec. 14, 2023

(51) Int. Cl. G01N 1/36

(52) U.S. Cl. CPC G01N 1/36

(57) ABSTRACT

A cassette for holding and orienting a tissue sample, includes a frame, a retaining assembly and a base. The frame defines an accommodating chamber. The retaining assembly is movably coupled to the frame and has a biasing member. The base is detachably coupled to the retaining assembly. The biasing member is configured to urge the tissue sample towards the base to holding the tissue sample between the base and the retaining assembly. The base is movable along with the retaining assembly relative to the frame between a first position where the base is received in the accommodating chamber and a second position where the base is protruded from the accommodating chamber. The cassette can be used both in tissue processing and embedding, and the orientation of the tissue sample is not necessary to change.

### FIELD

The present disclosure relates to a field of tissue processing and embedding, and more particularly to a cassette for holding and orienting a tissue sample.

### BACKGROUND

A biopsy is the removal of a tissue sample to examine tissue for signs of cancer or other disorders.

In order to properly process the tissue sample a series of steps may be performed including:
1. Grossing of the sample by cutting the sample to the proper size for analysis.
2. Processing of the sample to immobilize molecular components and/or prevent degradation, generally including fixation, dehydration, clearing and wax infiltration of the tissue sample.
3. Embedding the sample in an embedding material, such as paraffin wax.
4. Sectioning the embedded sample by using, for example, a microtome.

Currently, after the processing of the tissue sample, a user will manually open cassette and transfer tissue to an embedding mold, manually orientate and embed the tissue sample, and this reduces working efficiency.

CN104048864A proposes an apparatus for holding a tissue sample, which allows for the tissue sample to be oriented during the grossing step and to remain in the same orientation through all steps to the embedding step. The apparatus includes a retaining member and a base which cooperate to retain the tissue sample. The retaining member is retractable relative to the base to separate from the base.

### SUMMARY

Embodiments of the present disclosure seek to solve at least one of the problems existing in the related art to at least some extent.

According to an aspect of the present disclosure, cassette for holding and orienting a tissue sample is provided. The cassette for holding and orienting a tissue sample includes a frame defining an accommodating chamber; a retaining assembly movably coupled to the frame and having a biasing member; and a base detachably coupled to the retaining assembly. The biasing member is configured to urge the tissue sample towards the base to holding the tissue sample between the base and the retaining assembly; and the base is movable along with the retaining assembly relative to the frame between a first position where the base is received in the accommodating chamber and a second position where the base is protruded from the accommodating chamber.

In the cassette according to embodiments of the present disclosure, the base is coupled to the retaining assembly, and the retaining assembly is provided with a biasing member which urges the tissue sample towards the base. Thus, the tissue sample can be held and oriented between the base and the retaining assembly. Furthermore, the base is movable along with the retaining assembly relative to the frame between a first position where the base is received in the accommodating chamber and a second position where the base is protruded from the accommodating chamber. Thus, the cassette can be used both in tissue processing and embedding, and the orientation of the tissue sample is not necessary to change. Moreover, the base is detachably coupled to the retaining assembly, such that the base can be removed during the tissue embedding to finally obtain a wax block without the base embedded.

In some embodiment, the base includes a bottom and a side wall extending from an edge of the bottom, and the bottom defines a plurality of through holes. Thus, the base defines a cavity therein, for receiving the tissue sample. Moreover, reagents can flow through the through holes in the bottom, to facilitate tissue processing and embedding.

In some embodiment, the retaining assembly further includes a coupling member and an abutment member coupled to the coupling member through the biasing member, the coupling member is movably coupled to the frame, and the biasing member urges the abutment member towards the bottom of the base to hold the tissue sample between the abutment member and the base. Thus, the tissue sample can be stably held and oriented between the abutment member and the bottom of the base by the biasing member.

In some embodiment, the retaining assembly further includes an intermediate member movably coupled to the frame, the coupling member is coupled to the intermediate member, and the base is detachably coupled to the intermediate member. Thus, the base and the coupling member can be coupled to the frame by the intermediate member.

In some embodiment, the intermediate member includes a flange extending outwards from an outer side wall of the intermediate member, the frame includes a first limiting member provided at an inner side wall of the frame, and the first limiting member is fitted with the flange to limit the retaining assembly in the first position. Thus, the base can be held in the first position through cooperation between the flange and the first limiting member.

In some embodiment, the first limiting member includes a first protrusion extending inwards from the inner side wall of the frame, and the first protrusion supports a surface of the flange of the intermediate member facing the base. Thus, the first protrusion prevents the intermediate member from moving in a direction towards the base, and the base is held in the first position stably.

In some embodiment, the surface of the flange of the intermediate member facing the base defines a first groove, and the first protrusion is fitted in the first groove. Thus, the base can be held in the first position more stably.

In some embodiment, the first limiting member further includes a second protrusion extending inwards from the inner side wall of the frame, and the second protrusion abuts against a surface of the flange of the intermediate member facing away from the base. Thus, the second protrusion prevents the intermediate member from moving in a direction away from the base, and the base can firmly clamped in the first position by the first and second protrusions.

In some embodiment, the surface of the flange of the intermediate member facing away from the base defines a second groove, and the second protrusion is fitted in the second groove. Thus, the base can be held in the first position more stably.

In some embodiment, the frame includes a second limiting member provided at an inner side wall of the frame, and the second limiting member is fitted with the flange to limit the retaining assembly in the second position. Thus, the base can be held in the second position through cooperation between the flange and the second limiting member.

In some embodiment, the second limiting member includes a step extending inwards from an edge of the inner side wall of the frame close to the base, and the step supports the surface of the flange facing the base. Thus, the step can prevent the intermediate member from moving in the direction towards the base, and the base is held in the second position stably.

In some embodiment, the second limiting member includes a third protrusion extending inwards from the inner side wall of the frame, and the third protrusion abuts against the surface of the flange facing away from the base. Thus, the third protrusion can prevent the intermediate member from moving in the direction away from the base, and the base can firmly clamped in the second position by the step and the third protrusion.

In some embodiment, the base includes a hook portion extending from the side wall of the base towards the intermediate member, the intermediate member includes a slot defining in the outer side wall of the intermediate member, and the hook portion is fitted in the slot to couple the base to the intermediate member. Thus, base is detachably coupled to the intermediate member, and the assembly and disassembly of the base and the intermediate member are facilitated.

In some embodiment, the intermediate member includes a recessed hole in an inner side wall of the intermediate member, the coupling member is provided with a shaft portion extending outwards from an outer side wall of the coupling member, and the shaft portion is fitted in the recessed hole to couple the coupling member to the intermediate member pivotally. Thus, the coupling member can be easily opened to place the tissue sample in the base.

In some embodiment, the coupling member is provided with a lug extending outwards from the outer side wall of the coupling member, the intermediate member defines a receiving groove in a surface of the intermediate away from the base, and the lug is fitted in the receiving groove to limit the coupling member in the intermediate member. Thus, the coupling member could be prevented from pivoting towards the base further, and held in place.

In some embodiment, the intermediate member is provided with stopping portion extending from the surface of the intermediate member into the receiving groove, to prevent the coupling member from separating from the intermediate member. Thus, the coupling member could be prevented from pivoting away from the base, and the coupling member cannot be opened unintentionally.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is an exploded view of a cassette according to an embodiment of the present disclosure.

FIG. 2 is another exploded view of a cassette according to an embodiment of the present disclosure.

FIG. 3 is a perspective view of a cassette in a first position according to an embodiment of the present disclosure.

FIG. 4 is another perspective view of a cassette in a first position according to an embodiment of the present disclosure.

FIG. 5 is a sectional view of a cassette in a first position according to an embodiment of the present disclosure.

FIG. 6 is a perspective view of a cassette in a second position according to an embodiment of the present disclosure.

FIG. 7 is another perspective view of a cassette in a second position according to an embodiment of the present disclosure.

FIG. 8 is a sectional view of a cassette in a second position according to an embodiment of the present disclosure.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

In the specification, unless specified or limited otherwise, relative terms such as “central”, “longitudinal”, “lateral”, “front”, “rear”, “right”, “left”, “inner”, “outer”, “lower”, “upper”, “horizontal”, “vertical”, “above”, “below”, “up”, “top”, “bottom” as well as derivative thereof (e.g., “horizontally”, “downwardly”, “upwardly”, etc.) should be construed to refer to the orientation as then described or as shown in the drawings under discussion. These relative terms are for convenience of description and do not require that the present disclosure be constructed or operated in a particular orientation.

Terms concerning attachments, coupling and the like, such as “connected” and “interconnected”, refer to a relationship in which structures are secured or attached to one another either directly or indirectly through intervening structures, as well as both movable or rigid attachments or relationships, unless expressly described otherwise.

Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

In the description of the present disclosure, it should be understood that, unless specified or limited otherwise, the terms “mounted,” “connected,” and “coupled” and variations thereof are used broadly and encompass such as mechanical or electrical mountings, connections and couplings, also can be inner mountings, connections and couplings of two components, and further can be direct and indirect mountings, connections, and couplings, which can be understood by those skilled in the art according to the detail embodiment of the present disclosure.

According to embodiments of the present disclosure provides a cassette 1000 for holding and orienting a tissue sample 2000, including: a frame 100 defining an accommodating chamber 101; a retaining assembly 200 movably coupled to the frame 100 and having a biasing member 250; and a base 300 detachably coupled to the retaining assembly 200. The biasing member 250 is configured to urge the tissue sample 2000 towards the base 300 to holding the tissue sample 2000 between the base 300 and the retaining assembly 200; and the base 300 is movable along with the retaining assembly 200 relative to the frame 100 between a first position where the base 300 is received in the accommodating chamber 101 and a second position where the base 300 is protruded from the accommodating chamber 101.

In the cassette 1000 according to embodiments of the present disclosure, the base 300 is coupled to the retaining assembly 200, and the retaining assembly 200 is provided with a biasing member 250 which urges the tissue sample 2000 towards the base 300. Thus, the tissue sample 2000 can be held and oriented between the base 300 and the retaining assembly 200. Furthermore, the base 300 is movable along with the retaining assembly 200 relative to the frame 100 between a first position where the base 300 is received in the accommodating chamber 101 and a second position where the base 300 is protruded from the accommodating chamber 101. Thus, the cassette 1000 can be used both in tissue processing and embedding, and the orientation of the tissue sample 2000 is not necessary to change. Moreover, the base 300 is detachably coupled to the retaining assembly 200, such that the base 300 can be removed during the tissue embedding to finally obtain a wax block without the base 300 embedded.

In some embodiments, the base 300 includes a bottom 309 and a side wall 320 extending from an edge of the bottom 309, and the bottom 309 defines a plurality of through holes 311. Thus, the base 300 defines a cavity therein, for receiving the tissue sample 2000. Moreover, reagents can flow through the through holes 311 in the bottom 309, to facilitate tissue processing and embedding.

It could be understood that, the side wall 320 may extends vertically from the edge of the bottom 309, or the side wall 320 may extends obliquely from the edge of the bottom 309, which is not specifically limited herein.

In some embodiments, the retaining assembly 200 further includes a coupling member 230 and an abutment member 270 coupled to the coupling member 230 through the biasing member 250, the coupling member 230 is movably coupled to the frame 100, and the biasing member 250 urges the abutment member 270 towards the bottom 309 of the base 300 to hold the tissue sample 2000 between the abutment member 270 and the base 300. Thus, the tissue sample 2000 can be stably held and oriented between the abutment member 270 and the bottom 309 of the base 300 by the biasing member 250.

In some embodiments, the abutment member 270 defines a plurality of through holes 271. Thus, reagents can flow through the through holes 271 in the abutment member 270, to facilitate tissue processing and embedding.

In some embodiments, the coupling member 230, the biasing member 250 and the abutment member 270 are integrally formed. Thus, the cassette 1000 can have a simple structure.

In some embodiments, the retaining assembly 200 further includes an intermediate member 210 movably coupled to the frame 100, the coupling member 230 is coupled to the intermediate member 210, and the base 300 is detachably coupled to the intermediate member 210. Thus, the base 300 and the coupling member 230 can be coupled to the frame 100 by the intermediate member 210.

In some embodiments, the intermediate member 210 includes a flange 215 extending outwards from an outer side wall of the intermediate member 210, the frame 100 includes a first limiting member 110 provided at an inner side wall of the frame 100, and the first limiting member 110 is fitted with the flange 215 to limit the retaining assembly 200 in the first position. Thus, the base 300 can be held in the first position through cooperation between the flange 215 and the first limiting member 110.

In some embodiments, the first limiting member 110 includes a first protrusion 109 extending inwards from the inner side wall of the frame 100, and the first protrusion 109 supports a surface of the flange 215 of the intermediate member 210 facing the base 300. Thus, the first protrusion 109 prevents the intermediate member 210 from moving in a direction towards the base 300, and the base 300 is held in the first position stably.

In some embodiments, the surface of the flange 215 of the intermediate member 210 facing the base 300 defines a first groove 216, and the first protrusion 109 is fitted in the first groove 216. Thus, the base 300 can be held in the first position more stably.

In some embodiments, the first limiting member 110 further includes a second protrusion 111 extending inwards from the inner side wall of the frame 100, and the second protrusion 111 abuts against a surface of the flange 215 of the intermediate member 210 facing away from the base 300. Thus, the second protrusion 111 prevents the intermediate member 210 from moving in a direction away from the base 300, and the base 300 can firmly clamped in the first position by the first and second protrusions 109,111.

In some embodiments, the surface of the flange 215 of the intermediate member 210 facing away from the base 300 defines a second groove 217, and the second protrusion 111 is fitted in the second groove 217. Thus, the base 300 can be held in the first position more stably.

In some embodiments, the frame 100 include a second limiting member 114 provided at an inner side wall of the frame 100, and the second limiting member 114 is fitted with the flange 215 to limit the retaining assembly 200 in the second position. Thus, the base 300 can be held in the second position through cooperation between the flange 215 and the second limiting member 114.

In some embodiments, the second limiting member 114 includes a step 113 extending inwards from an edge of the inner side wall of the frame 100 close to the base 300, and the step 113 supports the surface of the flange 215 facing the base 300. Thus, the step 113 can prevent the intermediate member 210 from moving in the direction towards the base 300, and the base 300 is held in the second position stably.

In some embodiments, the second limiting member 114 includes a third protrusion 117 extending inwards from the inner side wall of the frame 100, and the third protrusion 117 abuts against the surface of the flange 215 facing away from the base 300. Thus, the third protrusion 117 can prevent the intermediate member 210 from moving in the direction away from the base 300, and the base 300 can firmly clamped in the second position by the step 113 and the third protrusion 117.

In some embodiments, the base 300 includes a hook portion 313 extending from the side wall 320 of the base 300 towards the intermediate member 210, the intermediate member 210 includes a slot 223 defining in the outer side wall of the intermediate member 210, and the hook portion 313 is fitted in the slot 223 to couple the base 300 to the intermediate member 210. Thus, base 300 is detachably coupled to the intermediate member 210, and the assembly and disassembly of the base 300 and the intermediate member 210 are facilitated.

In some embodiments, the base 300 includes a recess 315 defining in an outer side wall of the base 300. The recess 315 may engage a tool, or a machine to assist disassembly of the base 300 and the intermediate member 210.

In some embodiments, the intermediate member 210 includes a recessed hole 218 in an inner side wall of the intermediate member 210, the coupling member 230 is provided with a shaft portion 239 extending outwards from an outer side wall of the coupling member 230, and the shaft portion 239 is fitted in the recessed hole 218 to couple the coupling member 230 to the intermediate member 210 pivotally. Thus, the coupling member 230 can be easily opened to place the tissue sample 2000 in the base 300.

In some embodiments, the coupling member 230 is provided with a lug 241 extending outwards from the outer side wall of the coupling member 230, the intermediate member 210 defines a receiving groove 219 in a surface of the intermediate away from the base 300, and the lug 241 is fitted in the receiving groove 219 to limit the coupling member 230 in the intermediate member 210. Thus, the coupling member 230 could be prevented from pivoting towards the base 300 further, and held in place.

In some embodiments, the intermediate member 210 is provided with stopping portion 220 extending from the surface of the intermediate member 210 into the receiving groove 219, to prevent the coupling member 230 from separating from the intermediate member 210. Thus, the coupling member 230 could be prevented from pivoting away from the base 300, and the coupling member 230 cannot be opened unintentionally.

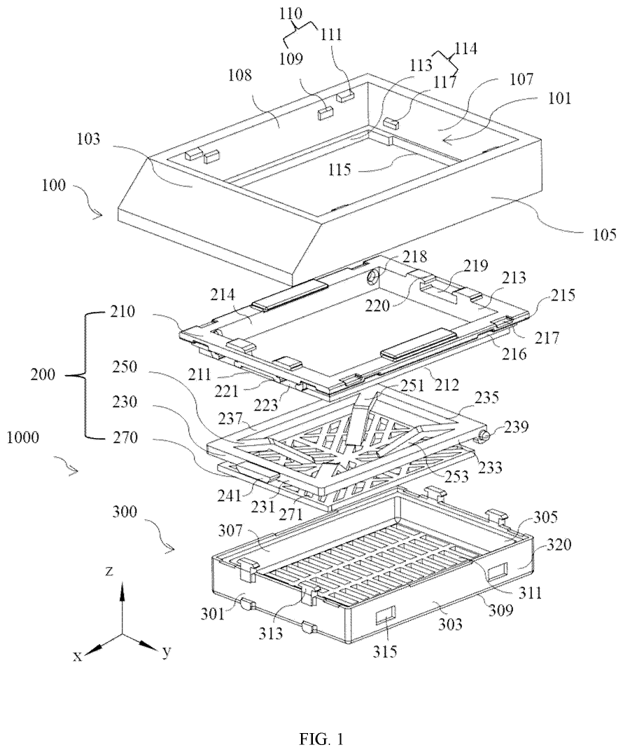

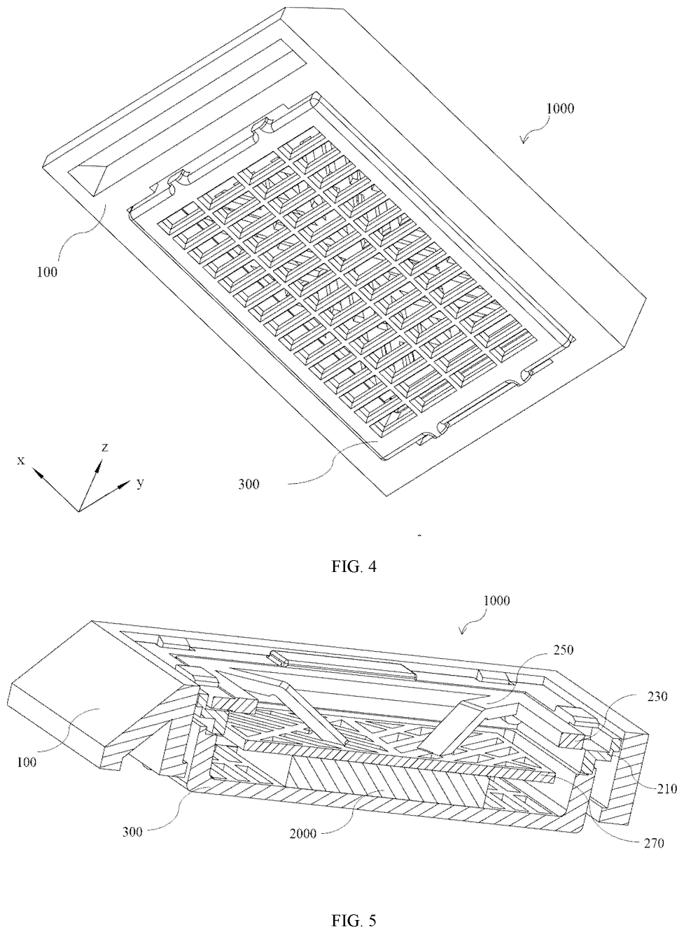

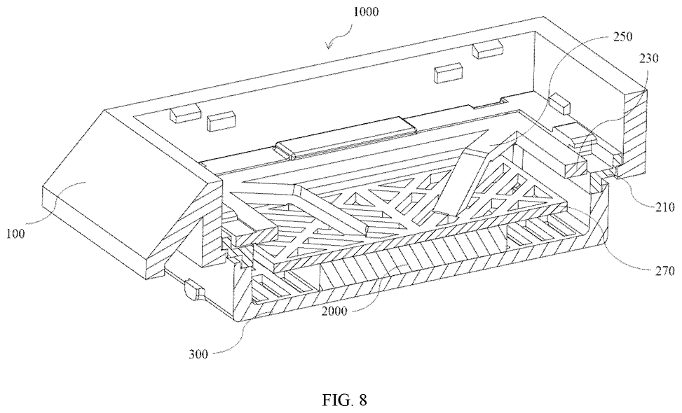

According to an embodiment of the present disclosure, a cassette 1000 for holding and orienting a tissue sample 2000 will be described in detail below with reference to FIGS. 1 to 8. The orthogonal XYZ-axis is illustrated in order to facilitate the description and determine the directions. In which, the positive direction of the X-axis is the front direction and the negative direction of the X-axis is the rear direction; the positive direction of the Y-axis is the right direction and the negative direction of the Y-axis is the left direction; the positive direction of the Z-axis is the up direction and the negative direction of the Z-axis down direction.

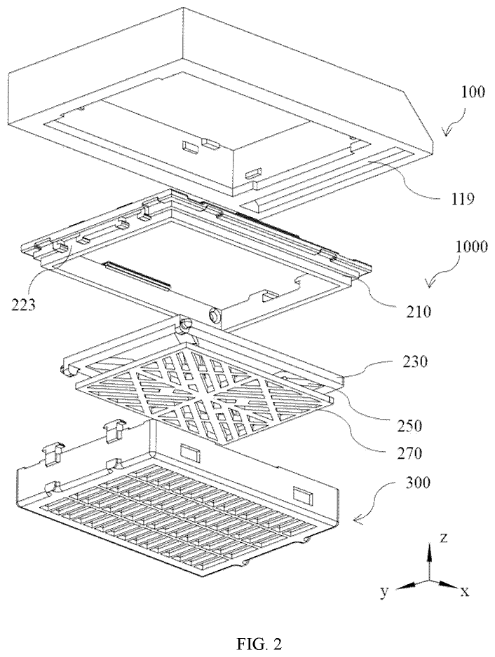

As illustrated in FIGS. 1 and 2, the cassette 1000 includes a frame 100, an intermediate member 210, a coupling member 230, a biasing member 250, an abutment member 270 and a base 300.

The frame 100 has a substantially rectangular shape, and defines an accommodating chamber 101 therein. The frame 100 includes a first side wall 103, a second side wall 105, a third side wall 107 and a fourth side wall 108 coupled end to end in sequence to enclose the accommodating chamber 101. The first and third side walls 107 are arrange oppositely in a front-rear direction, and the second and fourth side walls 108 are arrange oppositely in a left-right direction. The accommodating chamber 101 is opened to the outside in an up-down direction. That is, a top and a bottom of the frame 100 are opened.

The frame 100 is provided with two first protrusions 109 extending from an inner surface of the second side wall 105, and two first protrusions 109 extending from an inner surface of the fourth side wall 108. The two first protrusions 109 on the second side wall 105 and the two first protrusions 109 on the fourth side wall 108 are oppositely arranged respectively. The four first protrusions 109 have a same level, and are closer to a top edge of the frame 100 instead of a bottom edge of the frame 100.

The frame 100 is provided with two second protrusions 111 extending from the inner surface of the second side wall 105, and two second protrusions 111 extending from the inner surface of the fourth side wall 108. The two second protrusions 111 on the second side wall 105 and the two second protrusions 111 on the fourth side wall 108 are oppositely arranged respectively. The four second protrusions 111 have a same level, and are closer to the top edge of the frame 100 instead of the bottom edge of the frame 100. The four second protrusions 111 have a level higher than the four first protrusions 109. In addition, the second protrusions 111 are not aligned with the first protrusions 109 in the up-down direction.

The frame 100 is provided with a step 113 extending from an inner peripheral surface of the frame 100 at the bottom edge of the frame 100. That is, the step 113 is formed on the inner surfaces of the first to fourth side walls 103, 105, 107, 108. In addition, two notches 115 are defined in the step 113 at the first and third side walls 107 respectively.

The frame 100 is provided with two third protrusions 117 extending from the inner surface of the first side wall 103, and two third protrusions 117 extending from the inner surface of the third side wall 107. The two third protrusions 117 on the first side wall 103 and the two third protrusions 117 on the third side wall 107 are oppositely arranged respectively. The four third protrusions 117 have a same level, and are closer to the bottom edge of the frame 100 instead of the top edge of the frame 100. The four second protrusions 111 have a level higher than the step 113 and lower than the first protrusions 109.

The frame 100 is provided with an angled face at the first side wall 103. A label may be placed on the angled face to identify the tissue sample 2000. The angled face can be configured to receive a label such that the label clicks into the angled face of the frame 100. Alternatively, the frame 100 may have a textured surface and be put through an inkjet printing system, such as Leica IPC ink jet printer.

The frame 100 is further provided with an elongate groove 119 in a bottom surface of the frame 100 at the first side wall 103, and the elongate groove 119 extends in the left-right direction and used for grasping and handling by a user.

The intermediate member 210 has a substantially rectangular frame structure, and includes a first frame segment 211, a second frame segment 212, a third frame segment 213 and a fourth frame segment 214 coupled end to end in sequence. The first and third frame segments 213 are arrange oppositely in the front-rear direction, and the second and fourth frame segments 214 are arrange oppositely in the left-right direction.

The intermediate member 210 is provided with a flange 215 extending outwards from an outer peripheral surface at a top edge of the intermediate member 210. That is, the flange 215 is formed on outer surfaces of the first to fourth frame segments 211,212,213,214.

The intermediate member 210 is provided with two first grooves 216 defined in the bottom surface of the flange 215 at the second frame segment 212, and two first grooves 216 defined in the bottom surface of the flange 215 at the fourth frame segment 214. The two first grooves 216 at the second frame segment 212 and the two first grooves 216 at the fourth frame segment 214 are oppositely arranged respectively.

The intermediate member 210 is provided with two second grooves 217 defined in the top surface of the flange 215 at the second frame segment 212, and two second grooves 217 defined in the top surface of the flange 215 at the fourth frame segment 214. The two second grooves 217 at the second frame segment 212 and the two second grooves 217 at the fourth frame segment 214 are oppositely arranged respectively. The second grooves 217 are not aligned with the first grooves 216 in the up-down direction.

The intermediate member 210 is provided with two recessed holes 218 defined in an inner surface of the second frame segment 212, and two recessed holes 218 defined in an inner surface of the fourth frame segment 214, and the two recessed holes 218 in the second frame segment 212 and the two recessed holes 218 in the fourth frame segment 214 are oppositely arranged respectively. The two recessed holes 218 in the second frame segment 212 are arranged adjacent to two ends of the second frame segment 212, and the two recessed holes 218 in the fourth frame segment 214 are arranged adjacent to two ends of the fourth frame segment 214.

The intermediate member 210 is provided with a receiving groove 219 defined in the top surface of the first frame segment 211, and a receiving groove 219 defined in the top surface of the third frame segment 213. The receiving groove 219 of the first frame segment 211 is open at the inner surface of the first frame segment 211, and the receiving groove 219 of the third frame segment 213 is open at the inner surface of the third frame segment 213. The receiving grooves 219 in the first and third frame segments 213 are arranged oppositely.

The intermediate member 210 is provided with two stopping portions 220 extending oppositely from the top surface of the first frame segment 211 to the receiving groove 219 in the first frame segment 211, and two stopping portions 220 extending oppositely from the top surface of the third frame segment 213 to the receiving groove 219 in the third frame segment 213.

The intermediate member 210 is provided with two projections 221 extending from an outer surface of the first frame segment 211, and two projections 221 extending from an outer surface of the third frame segment 213. Each projection 221 defines a slot 223 in an outer side surface of the projection 221. Each slot 223 is opened downwards, and has a substantially T-shaped cross section along the front-rear direction.

The coupling member 230 has a substantially rectangular frame structure, and includes a first beam 231, a second beam 233, a third beam 235 and a fourth beam 237 coupled end to end in sequence. The first and third beams 235 are arranged oppositely in the front-rear direction, and the second and fourth beams 233, 237 are arranged oppositely in the left-right direction.

The coupling member 230 is provided with two shaft portions 239 extending from outer surfaces of the second and fourth beams 233, 237 respectively. The shaft portions 239 are provided at ends of the second and fourth beams 233, 237 opposite to each other.

The coupling member 230 is provided with a lug 241 extending from an outer side surface of the first beam 231.

The abutment member 270 has substantially a flat plate structure, and is provided with a plurality of though holes 271.

The cassette 1000 includes four biasing members 250, and each biasing member 250 includes a first arm 251 and a second arm 253 coupled to each other. The first arm 251 extends substantially horizontally, and the second obliquely extends downwards. The first arm 251 has a first end coupled to one of junctions of the first to fourth beams 231, 233, 235, 237, and a second end coupled to a first end of the second arm 253. A second end of the second arm 253 is coupled to the top surface of the abutment member 270. Thus, the four biasing members 250 are elastically coupled between the coupling member 230 and the abutment member 270. Furthermore, the coupling member 230, the four biasing members 250 and the abutment member 270 are integrally formed into one piece.

The base 300 has a substantially rectangular box structure, and includes first to fourth walls 301, 303, 305, 307, and a bottom 309. The first to fourth walls 301, 303, 305, 307 are coupled end to end in sequence, the first and third walls 301, 305 are arranged oppositely in the front-rear direction, and the second and fourth walls 303, 307 are arranged oppositely in the left-right direction. The bottom 309 is coupled to bottom edges of the first to fourth walls 301, 303, 305, 307. The base 300 defines an opening at its top. The bottom 309 is provided with a plurality of through holes 311.

The base 300 is provided with two hook portions 313 extending upwards from a top surface and an outer side surface of the first wall 301, and two hook portions 313 extending upwards from a top surface and an outer side surface of the third wall 305. The two hook portions 313 on the first wall 301 are arranged opposite to the two hook portions 313 on the third wall 305. Each hook portion 313 has a substantially T-shaped cross section in the front-rear direction.

The base 300 is provided with two recesses 315 in an outer side surface of the second wall 303, and two recesses 315 in an outer side surface of the fourth wall 307. The two recesses 315 in the second wall 303 are arranged opposite to the two recesses 315 in the fourth wall 307.

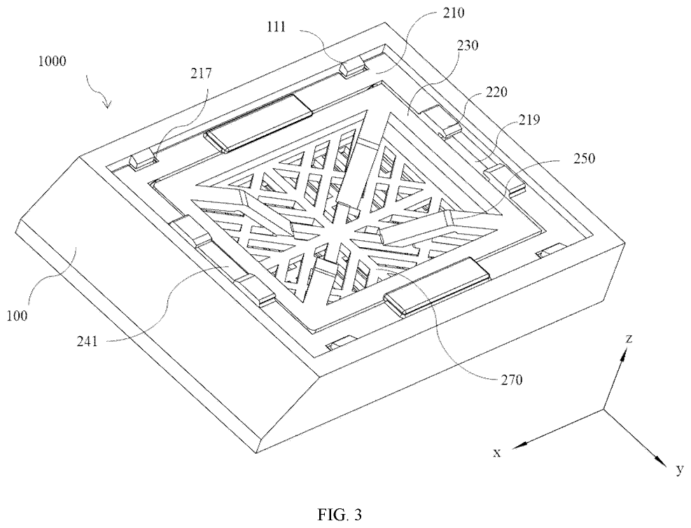

As illustrated in FIGS. 3 to 8, the shaft portions 239 of the coupling member 230 are fitted in two opposite recessed holes 218 in the intermediate member 210, such that the coupling member 230 is pivotally coupled to the intermediate member 210.

The lug 241 of the coupling member 230 is fitted in one receiving groove 219 of the intermediate member 210, such that pivoting of the coupling member 230 is limited by the intermediate member 210. Furthermore, the stopping portion 220 of the intermediate member 210 may prevent the lug 241 of the coupling member 230 from separating from the intermediate member 210 unintentionally. Thus, the coupling member 230 can be firmly received in the intermediate member 210.

The hook portions 313 of the base 300 are fitted into the slots 223 of the intermediate member 210 respectively, such that the base 300 is detachably coupled to the intermediate member 210.

The notches 115 allow passage of the hook portions 313.

As illustrated in FIGS. 3 to 5, the four first protrusions 109 of the frame 100 are fitted into the four first grooves of the intermediate member 210, and the four second protrusions 111 of the frame 100 are fitted into the four second grooves 217 of the intermediate member 210, such that the intermediate member 210 is firmly received in a first position where the base 300 is substantially received in the accommodating chamber 101 of the frame 100.

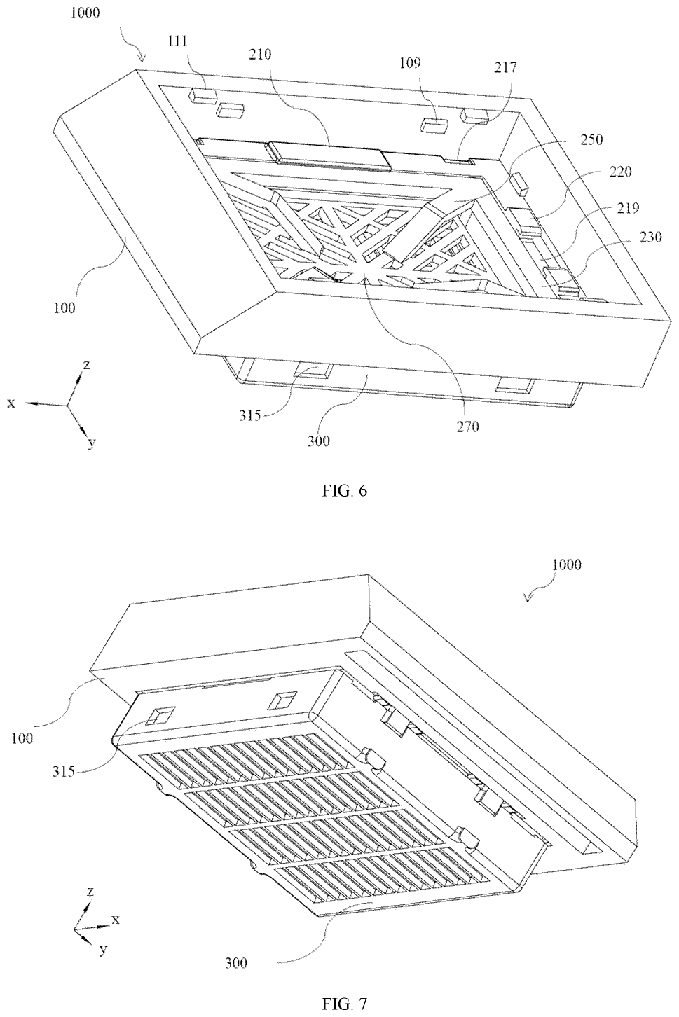

As illustrated in FIGS. 6 to 8, the bottom surface of the flange 215 of the intermediate member 210 abuts against the top surface of the step 113 of the frame 100, and third protrusions 117 of the frame 100 abut against the top surface of the flange 215 of the intermediate member 210, such that the intermediate member 210 is firmly received in a second position where the base 300 is protruded from the accommodating chamber 101. In this case, the recesses of the base 300 are exposed for assisting disassembly of the base 300 from the intermediate member 210.

The operation of the cassette 100 according to the embodiment of the present disclosure will be briefly described below.

The coupling member 230 is pivotally coupled to the intermediate member 210 through the shaft portions 239. Thus, the coupling member 230 may be opened and closed by pivoting it around the shaft portions 239 relative to the intermediate member 210.

As the coupling member 230, the four biasing members 250 and the abutment member 270 are integrally formed into one piece, when the coupling member 230 is opened, the lug 241 is separated from the receiving groove 219, the opening of the base 300 is exposed, and a tissue sample 2000 may be placed in the base 300. When the coupling member 230 is closed, the lug 241 is received in the receiving groove 219, the opening of the base 300 is closed, and the tissue sample 2000 is held and oriented between the bottom 309 of the base 300 and the abutment member 270 under the action of the biasing member 250. As the biasing member 250 is elastic, the cassette 1000 is suitable for holding and orienting the tissue sample 2000 of different thicknesses.

As illustrated in FIG. 3, the base 300 is received in the accommodating chamber 101. That is, the base 300 is in the first position. In this case, the cassette 300 is suitable for the tissue processing.

As illustrated in FIG. 6, the base 300 is protruded from the accommodating chamber 101. That is, the base 300 is in the second position. In this case, the cassette 1000 is suitable for the tissue embedding. The tissue sample 2000 in the second position of the base 300 has the same orientation as in the first position of the base 300.

Furthermore, the base 300 may be removed from the intermediate member 210 during the tissue embedding, and a wax block may be obtained without the base 300 embedded. The exposed recesses 315 may engage with a tool or machine to assist disassembly of the base 300 from the intermediate member 210.

In conclusion, the cassette 1000 according to the embodiments of the present disclosure reduces the manual handling of the tissue sample, and may facilitate automatic embedding of the tissue sample 2000.

It should be noted that, although the present disclosure has been described with reference to the embodiments, it will be appreciated by those skilled in the art that the disclosure includes other examples that occur to those skilled in the art to execute the disclosure. Therefore, the present disclosure is not limited to the embodiments.

### REFERENCE LIST

100 frame
101 accommodating chamber
103 first side wall
105 second side wall
107 third side wall
108 fourth side wall
109 first protrusion
110 limiting member
111 second protrusion
113 step
114 second limiting member
115 two notches
117 third protrusion
119 elongate groove
200 retaining assembly
210 intermediate member
211 first frame segment
212 second frame segment
213 third frame segment
214 fourth frame segment
215 flange
216 first groove
217 second groove
218 recessed hole
219 receiving groove
220 stopping portion
221 protrusion
223 slot
230 coupling member
231 first beam
233 second beam
235 third beam
237 fourth beam
239 shaft portion
241 lug
250 biasing member
251 first arm
253 second arm
270 abutment member
271 through holes
300 base
301 wall
303 wall
305 wall
307 wall
309 bottom
311 through holes
313 hook portion
315 recess
320 side wall
1000 cassette
2000 tissue sample

What is claimed is:

1. A cassette for holding and orienting a tissue sample, comprising:
a frame defining an accommodating chamber;
a retaining assembly movably coupled to the frame and having a biasing member; and
a base detachably coupled to the retaining assembly,
wherein the biasing member is configured to urge the tissue sample towards the base to holding the tissue sample between the base and the retaining assembly; and the base is movable along with the retaining assembly relative to the frame between a first position where the base is received in the accommodating chamber and a second position where the base is protruded from the accommodating chamber.

2. The cassette according to claim 1, wherein the base comprises a bottom and a side wall extending from an edge of the bottom, and the bottom defines a plurality of through holes.

3. The cassette according to claim 2, wherein the retaining assembly further comprises a coupling member and an abutment member coupled to the coupling member through the biasing member, the coupling member is movably coupled to the frame, and the biasing member urges the abutment member towards the bottom of the base to hold the tissue sample between the abutment member and the base.

4. The cassette according to claim 3, wherein the retaining assembly further comprises an intermediate member movably coupled to the frame, the coupling member is coupled to the intermediate member, and the base is detachably coupled to the intermediate member.

5. The cassette according to claim 4, wherein the intermediate member comprises a flange extending outwards from an outer side wall of the intermediate member, the frame comprises a first limiting member provided at an inner side wall of the frame, and the first limiting member is fitted with the flange to limit the retaining assembly in the first position.

6. The cassette according to claim 5, wherein the first limiting member comprises a first protrusion extending inwards from the inner side wall of the frame, and the first protrusion supports a surface of the flange of the intermediate member facing the base.

7. The cassette according to claim 6, wherein the surface of the flange of the intermediate member facing the base defines a first groove, and the first protrusion is fitted in the first groove.

8. The cassette according to claim 6, wherein the first limiting member further comprises a second protrusion extending inwards from the inner side wall of the frame, and the second protrusion abuts against a surface of the flange of the intermediate member facing away from the base.

9. The cassette according to claim 8, wherein the surface of the flange of the intermediate member facing away from the base defines a second groove, and the second protrusion is fitted in the second groove.

10. The cassette according to claim 5, wherein the frame comprises a second limiting member provided at an inner side wall of the frame, and the second limiting member is fitted with the flange to limit the retaining assembly in the second position.

11. The cassette according to claim 10, wherein the second limiting member comprises a step extending inwards from an edge of the inner side wall of the frame close to the base, and the step supports the surface of the flange facing the base.

12. The cassette according to claim 11, wherein the second limiting member comprises a third protrusion extending inwards from the inner side wall of the frame, and the third protrusion abuts against the surface of the flange facing away from the base.

13. The cassette according to claim 4, wherein the base comprises a hook portion extending from the side wall of the base towards the intermediate member, the intermediate member comprises a slot defining in the outer side wall of the intermediate member, and the hook portion is fitted in the slot to couple the base to the intermediate member.

14. The cassette according to claim 4, wherein the intermediate member comprises a recessed hole in an inner side wall of the intermediate member, the coupling member is provided with a shaft portion extending outwards from an outer side wall of the coupling member, and the shaft portion is fitted in the recessed hole to couple the coupling member to the intermediate member pivotally.

15. The cassette according to claim 14, wherein the coupling member is provided with a lug extending outwards from the outer side wall of the coupling member, the intermediate member defines a receiving groove in a surface of the intermediate away from the base, and the lug is fitted in the receiving groove to limit the coupling member in the intermediate member.

16. The cassette according to claim 15, wherein the intermediate member is provided with stopping portion extending from the surface of the intermediate member into the receiving groove, to prevent the coupling member from separating from the intermediate member.
